(19) United States
(12) Patent Application Publication
(10) Pub. No.: US 2013/0308259 A1
(43) Pub. Date: Nov. 21, 2013

(54) SERVER CABINET

(71) Applicants: AN-GANG LIANG, Shenzhen City (CN); ZHENG-HENG SUN, Tu-Cheng (TW)

(72) Inventors: AN-GANG LIANG, Shenzhen City (CN); ZHENG-HENG SUN, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/517,608

(22) Filed: Jun. 14, 2012

(30) Foreign Application Priority Data
May 16, 2012 (CN) 201210151592.8

(51) Int. Cl. G06F 1/16

(52) U.S. Cl. 361/679.02

(57) ABSTRACT

A server cabinet includes a rack and a server unit installed in the rack. The server unit includes a casing with a rear wall and a sidewall substantially perpendicular to the rear wall, a motherboard accommodated in the casing, an installing bracket installed to the rear wall adjacent to the sidewall, a connector apparatus received in the installing bracket and electrically connected to the motherboard, and a cable with a connector. The installing bracket defines a through hole adjacent to the sidewall. The connector apparatus is aligned with the through hole. The connector of the cable extends through the through hole to be connected to the connector apparatus.

### CROSS-REFERENCE OF RELATED APPLICATION

Relevant subject matter is disclosed in a pending U.S. patent application, titled “SERVER CABINET”, with the application Ser. No. 13/491,558, filed on Jun. 7, 2012, which is assigned to the same assignee as this patent application.

### BACKGROUND

1. Technical Field

The present disclosure relates to a server cabinet.

2. Description of Related Art

Server cabinets include a number of server units installed in a rack, and a number of cables connected between rear walls of the server units and the rack. However, in a disorderly fashion, the cables will occupy a large amount of space behind the server units in the rack.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an exemplary embodiment of a server cabinet, wherein the server cabinet includes a server unit.

FIG. 2 is an exploded, partially cutaway, isometric view of the circled portion II of the server unit of FIG. 1, wherein the server unit includes a casing, an installing bracket, and a connector apparatus.

FIG. 3 is an enlarged, isometric view of the installing bracket and the connector apparatus of FIG. 2, but viewed from another perspective.

FIG. 4 is an assembled, isometric view of the server unit of FIG. 2.

FIG. 5 is an exploded, partially cutaway, isometric view of the installing bracket of FIG. 2 and a shielding plate.

FIG. 6 is an assembled, isometric view of FIG. 5.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

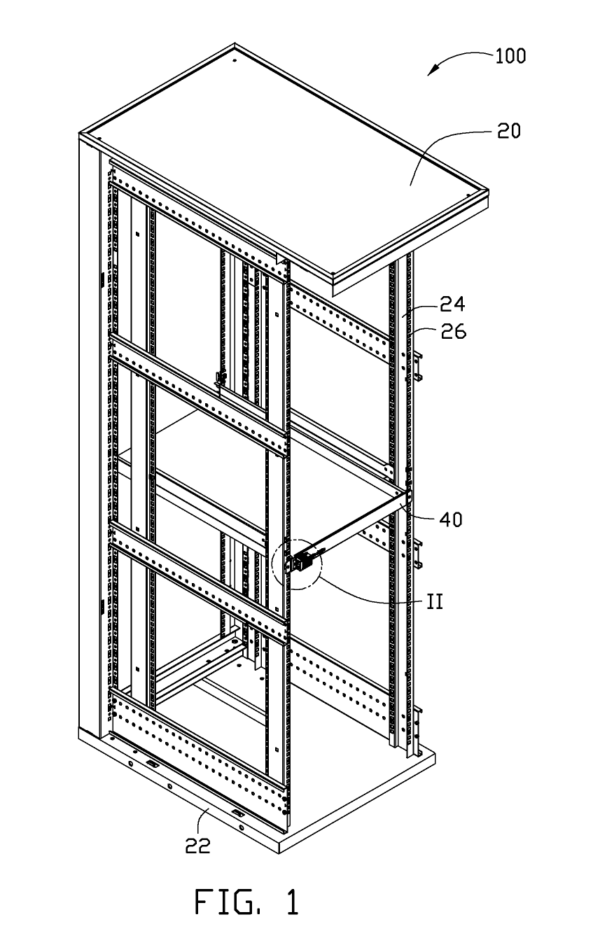

FIG. 1 shows an exemplary embodiment of a server cabinet 100 including a rack 20 and a server unit 40 installed in the rack 20.

The rack 20 includes a rectangular base 22 and four support poles 24 perpendicularly extending up from the base 22. Each support pole 24 defines a plurality of positioning holes 26, along the lengthwise direction of the support pole 24.

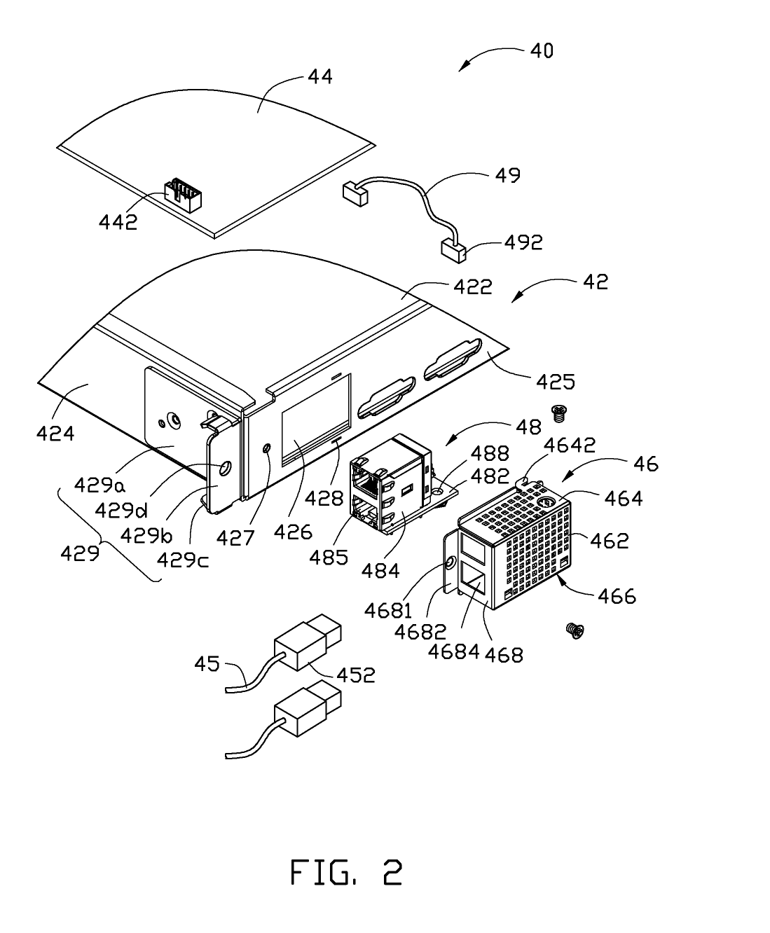

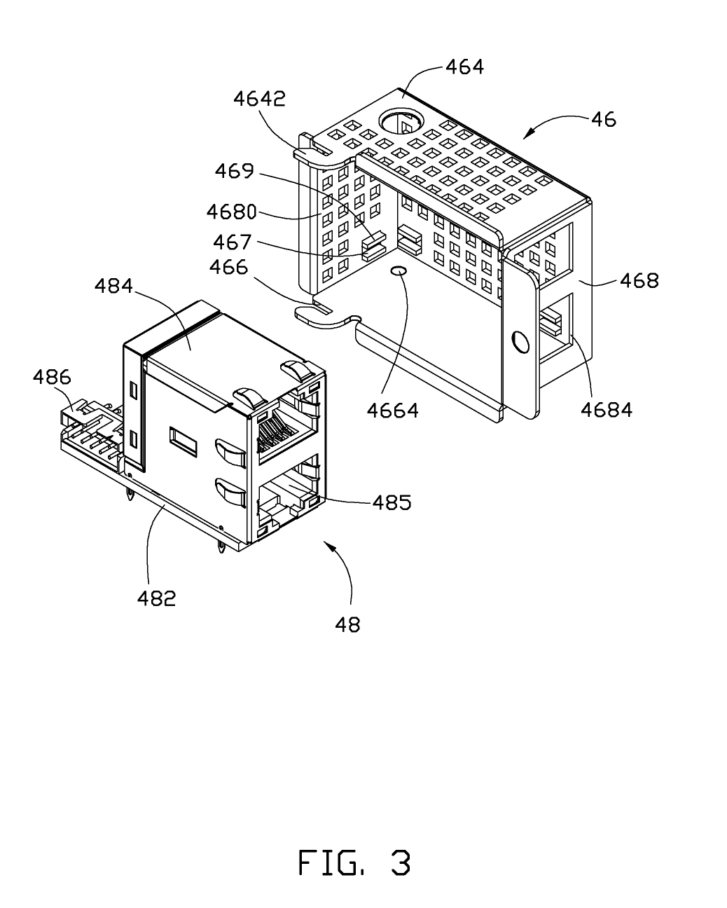

Referring to FIG. 2 and FIG. 3, the server unit 40 includes a casing 42, a motherboard 44, two first cables 45, an installing bracket 46, a connector apparatus 48, and a second cable 49.

The casing 42 includes a bottom wall 422, a sidewall 424 perpendicularly extending up from the bottom wall 422, and a rear wall 425 perpendicularly extending up from the bottom wall 422 and perpendicularly connected to a rear end of the sidewall 424. An opening 426 is defined in the rear wall 425, adjacent to the sidewall 424. The rear wall 425 defines a screw hole 427 located between the sidewall 424 and the opening 426, and two engaging holes 428 respectively located above and below the opening 426. A substantially L-shaped positioning member 429 is fixed on an outside surface of the sidewall 424, adjacent to the rear wall 425. The positioning member 429 includes a connecting plate 429a fixed on the sidewall 424, a positioning plate 429b perpendicularly extending out from a rear end of the connecting plate 429a, and two hooks 429c extending forward from a top end and a bottom end of the positioning plate 429b. The positioning plate 429b defines a locating hole 429d.

The motherboard 44 is substantially rectangular, and includes a first male connector 442 mounted on a side of the motherboard 44 and adjacent to a rear end of the motherboard 44.

A connector 452 is installed to an end of each cable 45. In the embodiment, the cables 45 are signal transmission lines.

The installing bracket 46 includes a rectangular rear plate 462, a first side plate 464 extending forward from a top side of the rear plate 462, a second side plate 466 extending forward from a bottom side of the rear plate 462 opposite to the first side plate 464, a first end plate 468 extending forward from a first end of the rear plate 462, and a second end plate 4680 extending forward from a second end of the rear plate 462 opposite to the first end plate 468. A flange 4682 perpendicularly extends out from a distal end of the first end plate 468 opposite to the rear plate 462. A middle of the flange 4682 defines an installing hole 4681. The first end plate 468 defines two through holes 4684. Two substantially L-shaped hooks 4642 respectively extend forward from the sides of the first and second side plates 464 and 466 opposite to the rear plate 462, and distal ends of the hooks 4642 extend toward the second end plate 4680. A plurality pairs of tabs 469 respectively extend in from inside surfaces of the rear plate 462 and the second end plate 4680, parallel to the second side plate 466. An inserting slot 467 is defined between each pair of tabs 469. A screw hole 4664 is defined in the second side plate 466, adjacent to the second end plate 4680.

The second cable 49 includes two female connectors 492 respectively installed to two distal ends of the second cable 49.

The connector apparatus 48 includes a rectangular circuit board 482, a connector assembly 484 mounted on a first end of the circuit board 482, and a second male connector 486 mounted on a front side of a second end of the circuit board 482 opposite to the first end. A rear side of the second end of the circuit board 482 defines an aligning hole 488. The connector assembly 484 includes two connectors 485.

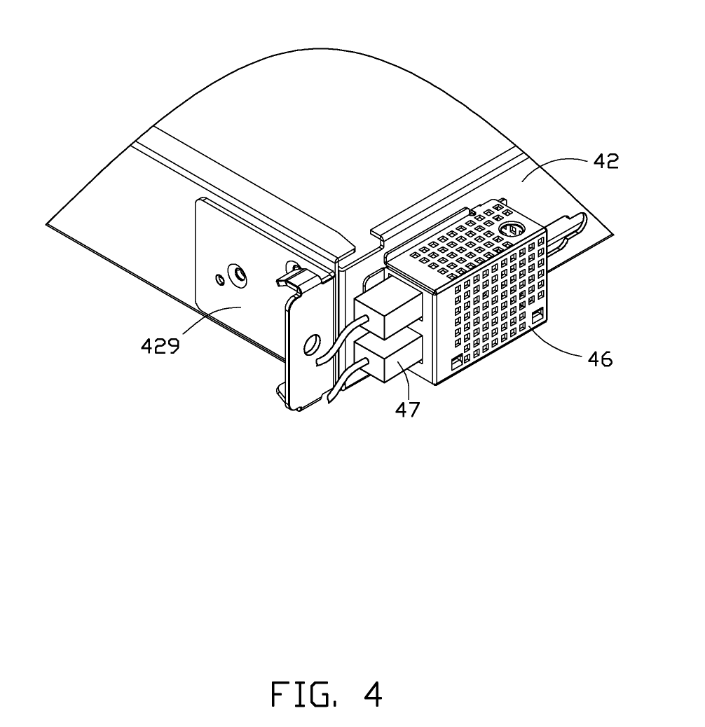

Referring to FIG. 4, in assembly of the server unit 40, the circuit board 482 of the connector apparatus 48 is inserted into the inserting slot 467, to allow the connector assembly 484 is received in the installing bracket 46. The connectors 485 respectively align with the through holes 4684. A screw extends through the aligning hole 488 of the circuit board 482, to be screwed into the screw hole 4664 of the installing bracket 46. The motherboard 44 is installed on the bottom wall 422 of the casing 42. The hooks 4642 of the installing bracket 46 are respectively engaged into the engaging holes 428, from an outside of the rear wall 425. A screw extends through the installing hole 4681 of the installing bracket 46 to screw into the screw hole 427 of the casing 42. The female connectors 492 of the second cable 49 are respectively connected to the first male connector 442 and the second male connector 486, with the second cable 49 extending through the opening 426.

In assembly of the server unit 40 to the rack 20, the server unit 40 is inserted into the rack 20. The hooks 429c of the positioning member 429 are respectively inserted into the positioning holes 26 of the corresponding support pole 24. A screw extends through the locating hole 429d of the positioning member 429, to fix in a corresponding positioning hole 26 between the hooks 429c. A front end wall of the server unit 40 opposite to the rear wall 425 and an end of the rear wall 425 away from the installing bracket 46 are fixed to the corresponding support poles 24 through screws. Thereby, the installing bracket 46 is located behind the support pole 24, and the connector 485 faces a same side as the support pole 24 opposite to the casing 42. The connectors 452 respectively extend through the through holes 4684, to be connected to the corresponding connectors 485 of the connector assembly 484.

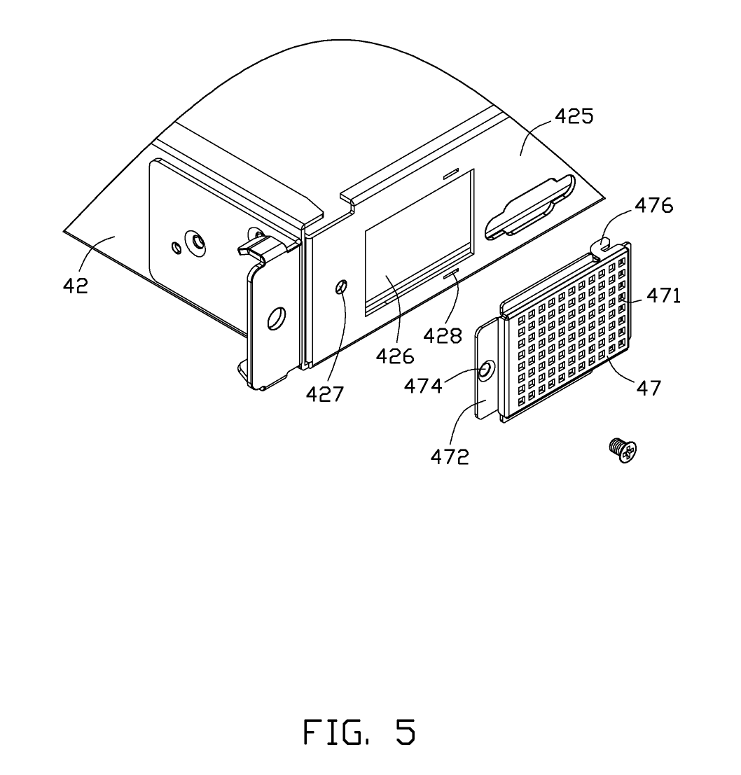

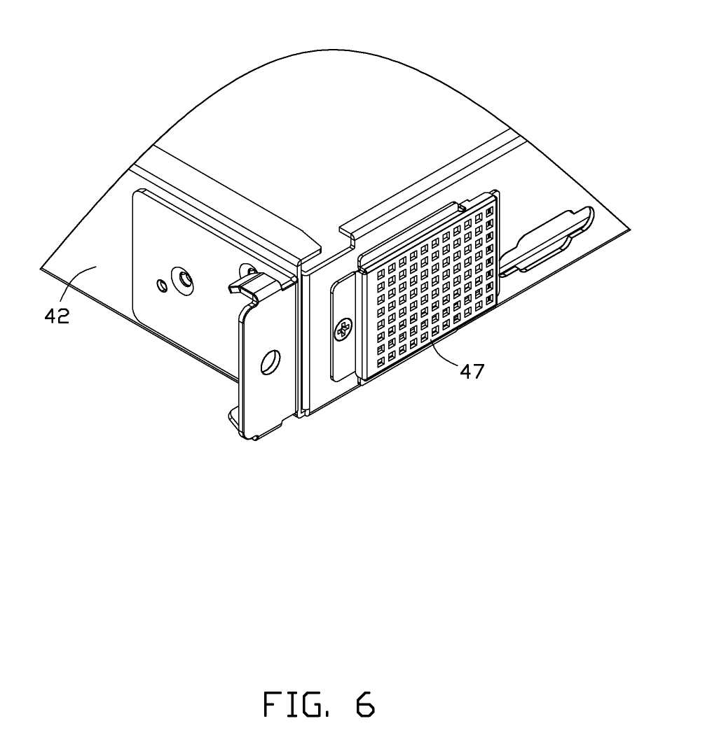

Referring to FIG. 5 and FIG. 6, a substantially rectangular shielding plate 47 is installed on the rear wall 425 of the casing 42 to cover the opening 426 when the server unit 40 is not installed with the connector apparatus 48. The shielding plate 47 defines a plurality of vents 471. Two L-shaped mounting plates 472 extend forward and out from two opposite ends of the shielding plate 47. A middle of one of the mounting plates 472 defines an installing hole 474, and two hooks 476 respectively extend forward from top and bottom sides of the shielding plate 47 adjacent to the other mounting plate 472. In assembly, the hooks 476 are respectively engaged into the engaging holes 428 of the casing 42 from the outside of the rear wall 425. A screw extends through the installing hole 474 to screw into the screw hole 427 of the casing 42.

In use, the installing bracket 46 is located behind the corresponding support pole 24, and the connectors 485 face a same side with the support pole 24 opposite to the casing 42, so the connectors 452 of the cables 45 directly extend through the through holes 4684 to be connected to the connectors 485. The cables 45 do not occupy a space behind the rear wall 425 of the casing 42.

Even though numerous characteristics and advantages of the embodiments have been set forth in the foregoing description, together with details of the structure and function of the embodiments, the present disclosure is illustrative only, and changes may be made in details, especially in the matters of shape, size, and arrangement of parts within the principles of the embodiments to the full extent indicated by the broad general meaning of the terms in which the appended claims are expressed.

What is claimed is:

1. A server, comprising:
a casing comprising a sidewall, and a rear wall perpendicular to the sidewall;
an installing bracket installed to an outer side of the rear wall adjacent to the sidewall, the installing bracket defining a through hole adjacent to the sidewall;
a motherboard accommodated in the casing; and
a connector apparatus received in the installing bracket and electrically connected to the motherboard, and comprising a first connector aligning with and exposed through the through hole.

2. The server of claim 1, wherein the installing bracket comprises a rear plate, a first side plate extending forward from a top side of the rear plate, a second side plate extending forward from a bottom side of the rear plate opposite to the first side plate, a first end plate extending forward from a first end of the rear plate adjacent to the sidewall of the casing, and a second end plate extending forward from a second end of the rear plate opposite to the first end plate, the through hole is defined in the first end plate.

3. The server of claim 2, wherein the connector apparatus comprises a circuit board installed on the second side plate of the installing bracket, the first connector is mounted on the circuit board.

4. The server of claim 3, wherein a pair of tabs extends in from the rear plate adjacent to the second side plate, the tabs parallel to the second side plate, an inserting slot is defined between the tabs, the circuit board is inserted into the inserting slot.

5. The server of claim 3, wherein the second side plate defines a screw hole adjacent to the second end plate, the circuit board defines an aligning hole opposite to the screw hole, a screw extends through the aligning hole, to be screwed into the screw hole.

6. The server of claim 3, wherein the motherboard comprises a first male connector, a second male connector is mounted on the circuit board, the rear wall defines an opening covered by the installing bracket, a cable with two female connectors are respectively connected to the first and second male connectors, with the cable extending through the opening.

7. The server of claim 6, wherein the rear wall defines a screw hole between the sidewall and the opening, a flange extends out from a distal end of the first end plate, the flange defines an installing hole, a screw extends through the installing hole to screw in the screw hole.

8. The server of claim 6, wherein the rear wall defines two engaging holes respectively located above and below the opening, two hooks respectively extend forward from the first and second side plate of the installing bracket, to engage into the engaging holes.

9. A server cabinet, comprising:
a rack; and
a server unit installed in the rack, and comprising a casing, an installing bracket, a motherboard accommodated in the casing, a connector apparatus received in the installing bracket and electrically connected to the motherboard, and a first cable with a first connector, the casing comprising a sidewall and a rear wall substantially perpendicular to the sidewall;
wherein the installing bracket is installed to an outer side of the rear wall adjacent to the sidewall, and the installing bracket defines a through hole adjacent to the sidewall, the connector apparatus comprises a second connector aligned with and exposed through the through hole, the first connector of the first cable extends through the through hole to be connected to the second connector.

10. The server cabinet of claim 9, wherein the installing bracket comprises a rear plate, a first side plate extending forward from a top side of the rear plate, a second side plate extending forward from a bottom side of the rear plate opposite to the first side plate, a first end plate extending forward from a first end of the rear plate adjacent to the sidewall of the casing, and a second end plate extending forward from a second end of the rear plate opposite to the first end plate, the through hole is defined in the first end plate.

11. The server cabinet of claim 10, wherein the connector apparatus comprises a circuit board installed on the second side plate of the installing bracket and a third connector mounted on the circuit board, the second connector is mounted on the circuit board.

12. The server cabinet of claim 11, wherein a pair of tabs extends in from the rear plate adjacent to the second side plate, the tabs are parallel to the second side plate, an inserting slot is defined between the tabs, the circuit board is inserted into the inserting slot.

13. The server cabinet of claim 11, wherein the second side plate defines a screw hole adjacent to the second end plate, the circuit board defines an aligning hole opposite to the screw hole, a screw extends through the aligning hole, to be screwed into the screw hole.

14. The server cabinet of claim 11, wherein the motherboard comprises a first female connector, a second female connector is mounted on the circuit board, the rear wall defines an opening covered by the installing bracket, a second cable with two male connectors are respectively connected to the first female connector and the second female connector, with the cable extending through the opening.

15. The server cabinet of claim 14, wherein the rear wall defines a screw hole between the sidewall and the opening, a flange extends out from a distal end of the first end plate, the flange defines an installing hole, a screw extends through the installing hole to screw in the screw hole.

16. The server cabinet of claim 14, wherein the rear wall defines two engaging holes respectively located above and below the opening, two hooks respectively extend forward from the first and second side plate of the installing bracket, to engage into the engaging holes.

17. The server cabinet of claim 9, wherein the rack comprise a base and a plurality of support poles extending up from the base, a positioning member is fixed on an outside surface of the sidewall adjacent to the installing bracket to be fixed to a corresponding support pole, the through hole faces a same side of the support pole, and behind the support hole.

18. The server cabinet of claim 17, wherein each support pole defines a plurality of positioning holes along a lengthwise direction of the support pole, the positioning member comprises a connecting plate fixed on the sidewall, a positioning plate extending out from a rear end of the connecting plate, and two hooks extending from two ends of the positioning plate to be respectively inserted into two positioning holes of the support pole.
